(19) United States
(12) Patent Application Publication
(10) Pub. No.: US 2014/0249278 A1
(43) Pub. Date: Sep. 4, 2014

(54) Novel Ionomer

(71) Applicants: NIHON UNIVERSITY, Tokyo (JP); San-ei Kougyou Corporation, Saitama (JP)

(72) Inventors: Takashi SAWAGUCHI, Tokyo (JP); Daisuke SASAKI, Tokyo (JP)

(21) Appl. No.: 14/280,042

(22) Filed: May 16, 2014

Related U.S. Application Data
(63) Continuation of application No. PCT/JP2012/079966, filed on Nov. 19, 2012.

(30) Foreign Application Priority Data
Nov. 17, 2011 (JP) 2011-251970

(51) Int. Cl. C08F 293/00

(52) U.S. Cl. CPC C08F 293/00
USPC 525/330.2; 525/330.6

(57) ABSTRACT

An ionomer has an ABA-type triblock structure, wherein an A-block is an ionic polymer block including a structural unit having a general formula (i) expressed as follows: —(CH₂—CR¹(COOM_{1/y})- where R¹ is one of a methyl group and hydrogen, M is one of metal, NH₄, organic ammonium and imidazolium, and y is a valence of an M ion, and a B-block is a nonionic polymer block selected from a group consisting of an olefin (co) polymer block, a vinyl (co) polymer block, a diene (co) polymer block, a polyester resin block and a polycarbonate resin block.

### CROSS REFERENCE TO RELATED APPLICATIONS

This is a continuation application of International Patent Application No. PCT/JP2012/079966 filed Nov. 19, 2012, which claims the benefit of Japanese Patent Application No. 2011-251970 filed Nov. 17, 2011, the full contents of all of which are hereby incorporated by reference in their entirety.

### TECHNICAL FIELD

The present disclosure relates to a novel ionomer.

### BACKGROUND ART

An ionomer is a material obtained by introducing a metal ion into a polymer to improve properties of the polymer per se and to add new functions to the polymer. Particularly, ethylene ionomers are used in applications such as food packaging, sporting goods, cosmetics containers and solar cell components.

An ethylene ionomers of the related art is obtained by neutralizing an ethylene-(meth) acrylate random copolymer, which is obtained by radical polymerization of ethylene and (meth) acrylate, using Na⁺, K⁺, Zn²⁺, or the like (e.g., see Japanese Laid-Open Patent Publication No. H05-194806 or Japanese Patent No. 4778902).

### SUMMARY

It is an object of the present disclosure to provide a novel ionomer having an ABA-type triblock structure.

The present inventors carried out assiduous studies, and as a result, reached the findings on a novel ionomer having an ABA-type triblock structure.

That is, the present disclosure relates to an ionomer having an ABA-type triblock structure, wherein

an A-block is an ionic polymer block including a structural unit having a general formula (i) expressed as follows:

—(CH₂—CR¹(COOM_{1/y})-

where

R¹ is one of a methyl group and hydrogen,

M is one of metal, NH₄, organic ammonium and imidazolium, and

y is a valence of an M ion; and

a B-block is a nonionic polymer block selected from a group consisting of an olefin (co) polymer block, a vinyl (co) polymer block, a diene (co) polymer block, a polyester resin block and a polycarbonate resin block.

Further, the present disclosure relates to the ionomer in which the B-block is an olefin (co) polymer block.

Further, the present disclosure relates to the ionomer in which the olefin (co) polymer block is selected from a group consisting of a polyethylene block, a polypropylene block, polyl-butene block, polyisobutylene block, a propylene-ethylene copolymer block, a propylene-1-butene copolymer block and an ethylene-1-butene copolymer block.

According to the present disclosure, a novel ionomer having an ABA-type triblock structure can be provided. The ionomer of the present disclosure has a high melting point, and thus has a good heat resistance.

### BRIEF DESCRIPTION OF DRAWINGS

FIG. 1 shows 1H-NMR spectra of PT, PT-Br, and PT-PtBA

FIG. 2 shows IR spectra of PT, PT-Br, PT-PtBA, PT-PAA, and PT-PAA/Na

FIG. 3 shows DSC measurement result of PT-PtBA, PT-PAA, and PT-PAA/Na

FIGS. 4A and 4B show dynamic viscoelasticity measurement results of films made of the product of the Example 1-3-2, the product of the Example 1-4-2 and the product of the Example 1-4-2 aged for two weeks.

FIGS. 5A and 5B show dynamic viscoelasticity measurement results of films made of the product of the Example 1-3-3, the product of the Example 1-4-3 and the product of the Example 1-4-3 aged for two weeks.

FIGS. 6A and 6B show dynamic viscoelasticity measurement results of films made of the product of the Example 1-4-3, the product of the Example 1-4-4 and the product of the Example 1-4-5.

### DETAILED DESCRIPTION

### Ionomer

The ionomer of the present disclosure has an ABA-type triblock structure.

A-block is an ionic polymer block including a structural unit having a general formula (i) expressed as follows:

—(CH₂—CR¹(COOM_{1/y})-.

R¹ represents one of a methyl group and hydrogen. M represents one of metal, NH₄, organic ammonium and imidazolium, and y represents a valence of an M ion. The metal is preferably an alkali metal such as Li, Na and K, an alkaline-earth metal such as Mg, Ca and Ba, a transition metal such as Zn, Cu, Mn, Co and Al. These metals may be used alone or as a combination thereof. Na is more preferable. An organic ammonium is formed by neutralizing a carboxyl group with an organic amine, and the organic amine may be a compound having a single amino group or a compound having a plurality of amino groups. The organic amine may be, for example, alkanolamine such as monoethanolamine, diethanolamine and triethanolamine, alkylamine such as methylamine, dimethylamine, triethylamine, ethylamine, diethylamine and triethylamine, diamine such as ethylenediamine, putrescine, hexamethylene diamine and phenylene diamine, and triamine such as melamine. Imidazolium is produced by neutralizing a carboxyl group with imidazolium salt. An imidazolium salt may be, for example, 1-ethyl-3-methyl-imidazolium salt, 1-butyl-3-methyl-imidazolium salt, 1,2,3-trimethyl-imidazolium salt, 1,2,3-triethyl-imidazolium salt, 1-ethyl-2,3-dimethyl-imidazolium salt, 2-hydroxyethyl-1,3-dimethyl-imidazolium salt. In an A-block, the content of the structural unit expressed as the general formula (i) is preferably in a range of 1 to 90 mass %, and particularly 10 to 50 mass %, in terms of achieving a good heat resistance.

The A-block may include, in addition to the structural unit expressed by the aforementioned general formula (i), a structural unit derived from other vinyl monomer other than the above. Other vinyl monomer may be, for example, (meth)acrylic acid esters such as methyl(meth)acrylate, ethyl(meth)acrylate, propyl(meth)acrylate, i-propyl(meth)acrylate, n-butyl(meth)acrylate, i-butyl(meth)acrylate, t-butyl(meth)acrylate, amyl(meth)acrylate, i-amyl(meth)acrylate, 2-ethylhexyl(meth)acrylate, n-octyl(meth)acrylate, i-octyl(meth)acrylate, decyl(meth)acrylate, i-decyl(meth)acrylate, dodecyl(meth)acrylate, i-dodecyl(meth)acrylate, stearyl(meth)acrylate, i-stearyl(meth)acrylate, behenyl(meth)acrylate, cyclopropyl(meth)acrylate, cyclobutyl(meth)acrylate, cyclopentyl(meth)acrylate, cyclohexyl(meth)acrylate, cycloheptyl(meth)acrylate, cyclooctyl(meth)acrylate, cyclononyl(meth)acrylate, cyclodecyl(meth)acrylate, isobomyl(meth)acrylate, norbornyl(meth)acrylate, adamantyl(meth)acrylate, benzyl(meth)acrylate, phenoxyethyl(meth)acrylate, aminoethyl(meth)acrylate, aminopropyl(meth)acrylate, methylaminoethyl(meth)acrylate, methylaminopropyl(meth)acrylate, ethylaminoethyl(meth)acrylate, ethylaminopropyl(meth)acrylate, 2,2,6,6-tetramethylpipericlinyl(meth)acrylate, dimethylaminoethyl(meth)acrylate, diethylaminoethyl(meth)acrylate, dimethylaminopropyl(meth)acrylate, diethylaminopropyl(meth)acrylate, phenoxyethyleneglycol(meth)acrylate, 2-naphthyl(meth)acrylate, 9-anthracenyl(meth)acrylate, polyethyleneglycol(meth)acrylate, methoxypolyethyleneglycol(meth)acrylate, ethoxypolyethyleneglycol(meth)acrylate, ethoxydiethyleneglycol(meth)acrylate, lauroyloxypolyethyleneglycol(meth)acrylate, stearoxypolyethyleneglycol(meth)acrylate, nonylphenoxypolyethyleneglycol(meth)acrylate, phenoxypolyethyleneglycol(meth)acrylate, polypropyleneglycol(meth)acrylate, poly(ethyleneglycol-propyleneglycol)(meth)acrylate, polyethyleneglycol-polypropyleneglycol(meth)acrylate, poly(ethyleneglycol-tetramethyleneglycol)(meth)acrylate, poly(propyleneglycol-tetramethyleneglycol)(meth)acrylate, polypropyleneglycol-polybutyleneglycol(meth)acrylate, octyloxypolyethyleneglycol-polypropyleneglycol(meth)acrylate, stearoxypolyethyleneglycol-polypropyleneglycol(meth)acrylate, aryloxypolyethyleneglycol-polypropyleneglycol(meth)acrylate, nonylphenoxypoly(ethyleneglycol-propyleneglycol)(meth)acrylate, hydroxymethyl(meth)acrylate, and 2-hydroxyethyl(meth)acrylate; vinyl ethers such as methyl vinyl ether, ethyl vinyl ether, n-propyl vinyl ether, i-propyl vinyl ether, i-butyl vinyl ether, t-butyl vinyl ether, dodecyl vinyl ether, stearyl vinyl ether, and polyethylene glycol vinyl ether; nitriles such as acrylonitrile and metacrylonitrile; vinyl halides such as vinyl chloride, vinylidene chloride, vinyl fluoride and vinylidene fluoride; allyl compounds such as allyl acetate and allyl chloride; vinylsilyl compounds such as vinyltrimethoxysilane; vinyl esters such as vinyl acetate and isopropenyl acetate; aromatic vinyls such as styrene, vinylnaphthalene, α-methylstyrene, t-butylstyrene, p-methylstyrene, o-methoxystyrene, m-methoxystyrene, p-methoxystyrene, o-t-butoxystyrene, m-t-butoxystyrene, p-t-butoxystyrene, o-chloromethylstyrene, m-chloromethylstyrene, p-chloromethylstyrene, vinyltoluene, ethylvinylbenzene, 4-vinylbiphenyl, 1,1-diphenylethylene, vinylphenol, vinylbenzoate and vinylnaphthalene; (meth)acrylamides such as (meth)acrylamide, methyl(meth)acrylamide, ethyl(meth)acrylamide, n-propyl(meth)acrylamide, i-propyl(meth)acrylamide, dimethyl(meth)acrylamide, N-(1,1-dimethyl-3-oxobutyl)acrylamide (diacetoneacrylamide), hydroxymethyl(meth)acrylamide, hydroxyethyl(meth)acrylamide, hydroxypropyl(meth)acrylamide, methoxymethyl(meth)acrylamide, ethoxymethyl(meth)acrylamide, methoxyethyl(meth)acrylamide, ethoxyethyl(meth)acrylamide, N,N-diethanol(meth)acrylamide, N-(2-(polyethylene glycol) ethyl)(meth)acrylamide, N,N-(2,2′-(polyethylene glycol)diethyl)(meth)acrylamide; and (meth)acrylic acid. Such other vinyl monomers may be used alone or as a combination thereof. Preferably, (meth)acrylate, methyl(meth)acrylate, ethyl(meth)acrylate, n-propyl(meth)acrylate, n-butyl(meth)acrylate, t-butyl(meth)acrylate, i-propyl(meth)acrylamide, hydroxyethyl(meth)acrylate, dimethylaminoethyl(meth)acrylate, (meth)acrylonitrile, or styrene. (meth)acrylic acid is more preferable.

In an A-block, the content of the structural unit derived from other vinyl system monomer is preferably in a range of 1 to 90 mass %, and particularly, 10 to 50 mass %. A number average molecular weight of the ionic polymer in an A-block is not particularly limited, but it is preferably in a range of 300 to 100000, and particularly in a range of 500 to 50000. A weight average molecular weight is not particularly limited, but it is preferably in a range of 500 to 1000000, and particularly in a range of 1000 to 500000.

B-block is a nonionic polymer block selected from a group consisting of an olefin (co)polymer block, a vinyl (co)polymer block, a diene (co)polymer block, a polyester resin block and a polycarbonate resin block.

An olefin (co)polymer has a structural unit which is preferably represented with a general formula (iii) described below:

—(CH₂—CHR²)-.

Each R² is independently selected from a group consisting of H, —CH₃, —C₂H₅ and —CH₂CH(CH₃)₂. That is, polyethylene (all R²'s are H), polypropylene (all R²'s are —CH₃), poly 1-butene (all R²'s are —C₂H₅), ethylene/propylene copolymer (R² is H or −CH₃), a propylene/1-butene copolymer (R² is —CH₃ or —C₂H₅), an ethylene/1-butene copolymer (R² is H or —C₂H₅) or poly 4-methyl-1-pentene (all R²'s are —CH₂CH(CH₃)₂) is induded. The olefin (co)polymer may be polyisobutylene. The copolymer includes both a random copolymer and a block copolymer. Polyethylene, polypropylene, a copolymer of propylene/ethylene, an ethylene/1-butene copolymer or polyisobutylene is preferable. Concerning resistance to heat, an ethylene/1-butene copolymer is more preferable. The number of repetitions of a structural unit represented by general formula (iii) is not particularly limited, but it is usually an integer of 10 to 3000. A number average molecular weight of the olefin (co)polymer constituting a B-block is not particularly limited, but it is preferably in the range of 300 to 100000, and particularly 500 to 50000. A weight average molecular weight is not particularly limited, but it is preferably in the range of 500 to 500000 particularly 1000 to 200000.

Vinyl (co)polymers are, for example, obtained by polymerization of vinyl monomers. The vinyl monomers may be (meth)acrylate esters, vinyl ethers, nitriles, vinyl halides, allyl compounds, vinylsilyl compounds, vinyl esters, aromatic vinyls and acrylamides described above. Styrene and methyl methacrylate are preferable. The number average molecular weight of a vinyl (co)polymer constituting a B-block is not particularly limited, but it is preferably in the range of 300 to 100000, and particularly in the range of 500 to 50000. The weight average molecular weight is not particularly limited, but it is preferably in the range of 500 to 500000, and particularly in the range of 1000 to 200000.

Diene (co)polymers are, for example, obtained by polymerization of diene monomers. A diene monomer may be 1,3-butadiene, isoprene, 1,3-pentadiene, 1,3-hexadiene, 2,3-dimethyl-1,3-butadiene, 2-ethyl-1,3-butadiene, 2-methyl-1,3-pentadiene, 3-methyl-1,3-pentadiene, 4-methyl-1,3-pentadiene and 2,4-hexadiene. Such diene monomers may be used alone or as a combination thereof. The copolymer includes both a random copolymer and a block copolymer. The diene monomer is more preferably 1,3-butadiene. The number average molecular weight of the diene (co)polymeric constituting the B-block is not particularly limited, but it is preferably in the range of 300 to 100000, and particularly, in the range of 500 to 50000. The weight average molecular weight is not particularly limited, but it is preferably in the range of 500 to 500000, and particularly in the range of 1000 to 200000.

Polyester resins are obtained by, for example, polycondensation of dicarboxylic acids with diols. Dicarboxylic acid may be terephthalic acid, isophthalic acid, malonic acid, succinic acid, glutaric acid, adipic acid, suberic acid, sebacic acid, maleic acid, and fumaric acid. Diol includes ethylene glycol, 1,3-propanediol, 1,2-propanediol, 1,4-butanediol, 1,3-butanediol, 1,2-butanediol, 1,5-heptanediol, 1,6-hexanediol, diethyleneglycol, triethyleneglycol, tetraethyleneglycol, 1,2-cyclohexanedimethanol, 1,3-cyclohexanedimethanol, 1,4-cydohexanedimethanol, tricyclodecanedimethanol, pentacyclopentadecanedimethanol, 2,6-decalindimethanol, 1,5-decalindimethanol, 2,3-decalindimethanol, 2,3-norbornanedimethanol, 2,5-norbornanedimethanol, 1,3-adamantanedimethanol, bisphenol A, 2,2-bis(4-hydroxy-3,5-dimethylphenyl)propane, 2,2-bis(4-hydroxy-3,5-diethylphenyppropane, 2,2-bis(4-hydroxy-(3,5-diphenyl)phenyl)propane, 2,2-bis(4-hydroxy-3,5-dibromophenyl)propane, 2,2-bis(4-hydroxyphenyl)pentane, 2,4′-dihydroxy-diphenylmethane, bis(4-hydroxyphenyl)methane, bis(4-hydroxy-5-nitrophenyl)methane, 1,1-bis(4-hydroxyphenyl)ethane, 3,3-bis(4-hydroxyphenyl)pentane, 1,1-bis(4-hydroxyphenyl)cyclohexane, bis(4-hydroxyphenyl)sulfone, 2,4′-dihydroxydiphenylsulfone, bis (4-hydroxyphenyl)sulfide, 4,4′-dihydroxydiphenylether, 4,4′-dihydroxy-3,3′-dichlorodiphenylether, 9,9-bis(4-hydroxyphenyl)fluorene, and 9,9-bis(4-hydroxy-2-methylphenyl)fluorene. As a polyester resin, a polyethylene terephthalate which is obtained by polycondensation of ethylene glycol with terephthalic acid is more preferable. The number average molecular weight of the polyester constituting the B-block is not particularly limited, but it is preferably in the range of 300 to 100000, and particularly 500 to 50000. The weight average molecular weight is not particularly limited, but it is preferably in the range of 500 to 500000 particularly preferably in the range of 1000 to 200000.

For example, the polycarbonate resin is obtained by reacting phosgene or diphenyl carbonate with diol. Diols may be diols described above. Polycarbonate obtained from bisphenol A is preferable. The number average molecular weight of a polycarbonate resin constituting a B-block is not particularly limited, but it is preferably in the range of 300 to 100000, and particularly preferably in the range of 500 to 50000. The weight average molecular weight is not particularly limited, but it is preferably in the range of 500 to 500000, and particularly preferably 1000 to 200000.

A preferable specific structure of the ionomer of the present disclosure can be expressed by general formula (iv) below.

X-A-CR³R⁴—C(═O)—O—B—O—C(═O)—CR³R⁴-A-X

A and B are an ionic polymer block and a nonionic polymer block, respectively, and R³ and R⁴ represent hydrogen, a methyl group or a phenyl group, independently and respectively. R³ and R⁴ may all be hydrogen atoms, or at least one may be also substituted for a functional group other than a hydrogen atom. When two are substituted for a functional group other than a hydrogen atom, those substituent groups may be the same or may be different. From the reactivity point of view, the one in which R³ is hydrogen and R⁴ is a methyl group, the one in which R³ is hydrogen and R⁴ is a phenyl group, or the one in which both R³ and R⁴ are methyl groups is preferable. X indicates a halogen atom, and it is preferably Cl, Br or I, and Br is the most preferable.

The number average molecular weight of the ionomer of the present disclosure is not particularly limited, but it is preferably in the range of 1000 to 1000000, and particularly, in the range of 2000 to 100000. The weight average molecular weight is not particularly limited, but it is preferably in the range of 2000 to 5000000, and it is particularly in the range of 3000 to 500000.

### Process of Preparing Ionomer

An ionomer of the present disclosure can be produced by, for example; producing a polyolefin halogenated at both ends from a polyolefin having hydroxy groups at both ends; producing a triblock copolymer by atom transfer radical polymerization between the obtained polyolefin halogenated at both ends and a vinyl monomer; hydrolyzing the obtained triblock copolymer; thereafter, introducing metal ions, ammonium ion, organic ammonium ions or imidazolium ions. Also, by producing a polyester resin halogenated at both ends from a polyester resin having hydroxy groups at both ends and producing a polycarbonate resin from halogenated at both ends from a polycarbonate resin, an ionomer can be produced with a method similar to the production method of the polyolefin.

The polyolefin having hydroxy groups at both ends is commonly available. For example, an ethylene/1-butene copolymer having hydroxy groups at both ends is available as “polytail” (manufactured by Mitsubishi Chemical Corporation) which is a hydrogenated polybutadiene.

The polyolefin having hydroxy groups at both ends can be produced by hydroxylating a polyolefin having double bonds at both ends.

The polyolefin having double bonds at both ends is obtained as a thermal degradation product of polyolefin by controlled thermal degradation developed by the present inventors (see Macromolecules, 28, 7973 (1995)).

Taking polypropylene as an example, a thermal degradation product of polypropylene obtained by an advanced controlled thermal degradation method has properties that a number average molecular weight Mn is around 1000 to 50000, a dispersity index Mw/Mn is around 2, an average number of vinylidene groups per molecule is around 1.5 to 1.8, and stereoregularity of the pre-degradation raw material polypropylene is maintained. A weight average molecular weight of the pre-degradation raw material polypropylene is preferably within a range of 10000 to 1000000, and more preferably 200000 to 800000.

A thermal degradation apparatus may be an apparatus disclosed in Journal of Polymer Science: Polymer Chemistry Edition, 21, 703 (1983). Polypropylene is placed in glass reaction container of a thermal degradation apparatus made of a pyrex (R) and undergoes thermal degradation reaction at a predetermined temperature for a predetermined time while suppressing secondary reaction by vigorously bubbling a molten polymer phase with nitrogen gas under a reduced pressure to extract a volatile product. After the thermal degradation reaction, the residual in the reaction container is dissolved in heated xylene and, after thermal filtration, reprecipitated with alcohol, and purified. A reprecipitated product is filtered, collected, and dried in vacuum to obtain polypropylene having a terminal double bond at both ends.

Conditions of thermal degradation are adjusted by predicting a molecular weight of a product from a molecular weight of polypropylene before degradation and a primary construction of a block copolymer of a final product and taking into consideration the result of an experiment performed beforehand. The thermal degradation temperature is preferably in a range of 300° C. to 450° C. At a temperature lower than 300° C., the thermal degradation reaction of polypropylene may not progress sufficiently, and at a temperature higher than 450° C., deterioration of thermal degradation product may progress.

Hydroxylation is accomplished by hydroxylating double bonds of an oligo olefin having vinylidene bonds at both ends obtained by the aforementioned method by hydroboration followed by an oxidation reaction. For example, using tetrahydrofuran as a solvent, firstly, a boronation reagent is added for hydroboration. 9-borabicyclononane or a borane-tetrahydrofuran complex may be used as the boronation reagent. A hydrogen peroxide solution is added to a reaction solution after the hydroboration, and after an oxidation reaction, a polyolefin having hydroxyl groups at both ends is obtained.

Also, for example, polyethylene having hydroxyl groups at both ends can be produced by using benzylidene-bis(tricyclohexylphosphine)dichlororuthenium (Grubbs catalyst), polymerizing cyclooctadiene and cis-1,4-bis(acetoxy)-2-butene, and thereafter hydrogenating.

Subsequently, the polyolefin having hydroxyl groups at both ends obtained as described above is esterificated using a suitable α-halo acyl halide to obtain oligoolefin halogenated at both ends.

Here, α-halo acyl halide means acyl halide in which carbon at an α position is halogenated, and can be represent by a general formula (v):

X₁C(═O)CR³R⁴X₂

X₁, X₂ represent halogen atoms, and, from a reaction property point of view, Cl or Br is preferable. R³ and R⁴ represent hydrogen, a methyl group or a phenyl group, independently and respectively. R₃ and R₄ may all be hydrogen atoms, or at least one may be substituted by a functional group other a hydrogen atom. When two are substituted by functional groups other a hydrogen atom, those substituent groups may be the same or may be different. From reactivity point of view, the one in which R³ is hydrogen and R⁴ is a methyl group, the one in which R³ is hydrogen and R⁴ is a phenyl group, or the one in which both R³ and R⁴ are methyl groups is preferable.

Reaction can be conducted by a normal esterification reaction using an acid halogenated compound and alcohol. Specifically, in the presence of the base, such as triethylamine, an α-halo acyl halide and a polyolefin having hydroxyl groups at both ends may be reacted.

Then, the polyolefin halogenated at both ends described above is used as an initiator, and atom transfer radical polymerization with the commonly known vinyl monomers is performed to obtain an ABA-triblock copolymer. The vinyl monomer may be (meth)acrylic acid esters described above, vinyl ethers, nitriles, vinyl halides, allyl compounds, vinylsilyl compounds, vinyl esters, aromatic vinyls, and acrylamides. Methyl(meth)acrylate, ethyl(meth)acrylate, n-propyl(meth)acrylate, n-butyl(meth)acrylate, t-butyl(meth)acrylate, i-isopropyl(meth)acrylamide, 2-hydroxyethyl(meth)acrylate, dimethylaminoethyl(meth)acrylate, (meth)acrylonitrile, or styrene is preferable. Such vinyl monomers may be used alone or as a combination thereof, but at least one is a monomer that can be hydrolyzed. As a monomer that can be hydrolyzed, it is preferable to use t-butyl(meth)acrylate. When combining a plurality of such vinyl monomers, these may be random copolymers or block copolymers.

The atom transfer radical polymerization is a known polymerization method in which polymerization is carried out by using an organohalides or a sulfonyl halide compound as an initiator and using a metal complex having elements in group 8, group 9, group 10 or group 11 in the periodic table as a catalyst. (E.g., see Matyjaszewski et. al., in Journal of American Chemical Society (J. Am. Chem. Soc.), 1995, vol. 117, p. 5614, Macromolecules, 1995, vol. 28, p. 7901, and Science, 1996, vol. 272, p. 866, and Sawamoto et. al., Macromolecules, 1995, vol. 28, p. 1721).

The transition metal complex used as a catalyst of the atom transfer radical polymerization is not particularly limited, but preferably a complex of monovalent or zero-valent copper, divalent ruthenium, divalent iron, and divalent nickel. Among these, a copper complex is preferable considering the cost and reaction control.

A monovalent copper compound is, for example, cuprous chloride, cuprous bromide, cuprous iodide, cuprous cyanide, cuprous oxide, cuprous perchlorate. Considering the control of polymerization, cuprous chloride and cuprous bromide are preferable.

Ligands to be used are not particularly limited, but may be appropriately determined from a relationship between the required rates of reaction, taking the initiator, the monomer and the solvent into consideration. When a monovalent copper compound is used, the ligand may be a 2,2′-bipyridyl compound such as 2,2′-bipyridyl and derivatives thereof (e.g., 4,4′-dinolyl-2,2′-bipyridyl, 4,4′-di(5-nolyl)-2,2′-bipyridyl, or the like), 1,10-phenanthroline compound such as 1,10-phenanthroline and derivatives thereof (e.g., 4,7-dinolyl-1,10-phenanthroline, 5,6-dinolyl-1,10-phenanthroline, or the like), polyamines such as tetramethylethylenediamine (TMEDA), pentamethyldiethylenetriamine (PMDETA), hexamethyl(2-aminoethyl)amine can be used.

Also, a tris-triphenylphosphine complex of divalent ruthenium chloride (RuCl₂(PPh₃)₃) is preferable as a catalyst. When a ruthenium compound is used as a catalyst, aluminum alkoxides may be added as an activating agent. Further, a bis-triphenylphosphine complex (FeCl₂(PPh₃)₂) of divalent iron, a bis-triphenylphosphine complex (NiCl₂(PPh₃)₂) of divalent nickel, and a bis-tributylphosphine complex (NiBr₂(PBu₃)₂) of divalent nickel is preferable as a catalyst.

Polymerization reaction can be usually conducted in the range of the room temperature of up to 200° C., and preferably 50 to 100° C.

Then, the aforementioned ABA-type triblock copolymer is hydrolyzed to obtain an ABA-type triblock copolymer hydrolysate. For example, hydrolysis is carried out by adding trifluoroacetic acid to the ABA-type triblock copolymer.

Then, ionomer of the present disclosure is obtained by introducing metal ions, ammonium ions, organic ammonium ions or imidazolium ions into the ABA-type triblock copolymer hydrolysate described above. Ionization may be performed at a part or all of them. A degree of ionization can be represented by a “degree of neutralization”. The metal ions can be introduced by adding a metal oxidate, a metal hydroxide, a metal carbonate, or the like to the ABA-type triblock copolymer hydrolysate. The metal is preferably an alkali metal such as Li, Na and K, an alkaline-earth metal such as Mg, Ca and Ba, and a transition metal such as Zn, Cu, Mn, Co and Al. Such metals may be used alone or as a combination thereof. Na is more preferable. Introduction of the ammonium ions can be achieved by adding ammonia to the ABA-type triblock copolymer hydrolysate. Introduction of the organic ammonium ions can be achieved by adding organic amine to the ABA-type triblock copolymer hydrolysate. The organic amine may either be a compound having a single amino group or a compound having a plurality of amino groups. The organic amine may be, for example, alkanolamine such as monoethanolamine, diethanolamine and triethanolamine; alkylamine such as methylamine, dimethylamine, triethylamine, ethylamine, diethylamine and triethylamine; diamine such as ethylenediamine, putrescine, hexamethylenediamine and phenylenediamine; and triamine such as melamine. Introduction of the imidazolium ions can be achieved by adding imidazolium salt to the ABA-type triblock copolymer hydrolysate. The imidazolium salt may be, for example, 1-ethyl-3-methyl-imidazolium salt, 1-butyl-3-methyl-imidazolium salt, 1,2,3-trimethyl-imidazolium salt, 1,2,3-triethyl-imidazolium salt, 1-ethyl-2,3-dimethyl-imidazolium salt, and 2-hydroxyethyl-1,3-dimethyl-imidazolium salt.

### EXAMPLE

Hereinafter, the present disclosure will be described in detail with reference to examples, but the present disclosure is not limited thereto. Note that in each of the examples, a 1H-NMR spectrum was measured with JNM-GX400 manufactured by JEOL Ltd., and an IR spectrum was measured with Perkin-Elmer 6100. A molecular weight was measured with a GPC analysis apparatus (HLC-8121GPC/HT (manufactured by Tosoh Corporation)). The measurement was carried out using orthodichlorobenzene as a mobile phase, and a polystyrene equivalent molecular weight was obtained.

### Example 1-1

### Synthesis of Both End-Brominated Ethylene/1-Butene Copolymer (PT-Br)

20 g of polytail (from Mitsubishi Chemical Corp, Mn: 6200, hereinafter referred to as PT), 5.8 ml of triethylamine and 100 ml of chloroform were placed in a reactor, and after a nitrogen purge, a chloroform solution of 2-bromoisobutyryl bromide (BiBB) (BiBB/CHCl₃=5 ml/20 ml) was added dropwise and stirred at room temperature for 24 hours. After the reaction, a reaction solution was poured into a 1N HCl/methanol solution, reprecipitated and refined to synthesize PT-Br.

### Example 1-2-1

### Synthesis of Poly(t-butylacrylate)-Ethylene/1-Butene Copolymer-Poly(t-butylacrylate) (PT-PtBA)

3 g of PT-Br obtained in Example 1-1 and 89.3 mg of copper bromide (I) were placed in a Schlenk tube, and after a nitrogen purge, 7.2 ml of t-butylacrylate, 15 ml of o-xylene and 125.7 μl of 1,1,4,7,7-pentamethyldiethylenetriamine (PMDETA) were added, and heated and stirred at 120° C. for five hours. After the termination of the reaction, a reaction solution was poured into methanol, and reprecipitated and refined. The obtained PT-PtBA had Mn of 16000 and Mw/Mn of 1.8.

### Example 1-2-2

The quantity of t-butylacrylate in Example 1-2-1 was changed from 7.2 ml to 1.8 ml. The obtained PT-PtBA had Mn of 10700 and Mw/Mn of 1.9.

### Example 1-2-3

The quantity of t-butylacrylate in Example 1-2-1 was changed from 7.2 ml to 2.7 ml. The obtained PT-PtBA had Mn of 11000 and Mw/Mn of 1.6.

### Example 1-3-1

### Synthesis of Polyacrylic Acid-Ethylene/1-Butene Copolymer-Polyacrylic Acid (PT-PAA)

1 g of PT-PtBA obtained in Example 1-2-1 was placed in a flask and, after a nitrogen purge, 4.5 ml of trifluoroacetic acid and 20 ml of dehydration chloroform were added and stirred at room temperature for two hours. After the reaction, the solvent, trifluoroacetic acid and t-butyl alcohol were removed by distillation and PT-PAA was obtained.

### Example 1-3-2

Similarly to the method of Example 1-3-1, PT-PAA was obtained from PT-PtBA obtained in Example 1-2-2.

### Example 1-3-3

Similarly to the method of Example 1-3-1, PT-PAA was obtained from PT-PtBA provided in Example 1-2-3.

### Example 1-4-1

### Synthesis of Ionomer: Sodium Polyacrylate-Ethylene/1-Butene Copolymer-Sodium Polyacrylate (PT-PAA/Na)

To a methanol dispersion of PT-PAA (1 g) obtained in Example 1-3-1, 6.5 ml of 1N sodium hydroxide aqueous solution was added dropwise and stirred. Then, PT-PAA/Na, which is an ionomer, was obtained as sediment. A degree of neutralization was 100%. Herein, the degree of neutralization represents an equivalent of the sodium hydroxide to a COOH group of PAA.

### Example 1-4-2

To a methanol dispersion of PT-PAA (1 g) obtained in Example 1-3-2, 3.9 ml of 1N sodium hydroxide aqueous solution was added dropwise and stirred. Then, PT-PAA/Na, which is an ionomer, was obtained as sediment. The degree of neutralization was 100%.

### Example 1-4-3

To a methanol dispersion of PT-PAA (1 g) obtained in Example 1-3-3, 4.1 ml of 1N sodium hydroxide aqueous solution was added dropwise and stirred. Then, PT-PAA/Na, which is an ionomer, was obtained as sediment. The degree of neutralization was 100%.

### Example 1-4-4

The 1N sodium hydroxide aqueous solution in Example 1-4-3 was changed from 4.1 ml to 2.05 ml. The degree of neutralization was 50%.

### Example 1-4-5

The 1N sodium hydroxide aqueous solution in Example 1-4-3 was changed from 4.1 ml to 8.2 ml. The degree of neutralization was 200%.

### Example 2-1

### Synthesis of Both End-Brominated Polypropylene (iPP-Br)

First, polypropylene having double bonds at both ends (iPP-TVD) is synthesized. Then, iPP-TVD was hydroxylated, and the obtained both end-hydroxy polypropylene (iPP-OH) was brominated to obtain a both end-brominated polypropylene (iPP-Br). It will be described in detail below.

A lab-scale advanced control thermal degradation apparatus of a maximum sampling size of 5 kg was used as a thermal degradation apparatus. 2 kg of commercially available isotactic polypropylene ((novatec-PP (manufactured by Japan Polypropylene Corporation), grade: EA9A, melt flow index (MFR): 0.5 g/10 min) was placed in a reactor, and melted by heating the reactor to 200° C. after a nitrogen purge and the depressurizing of the system to 2 mmHg. Thereafter, the reactor was immersed into a metal bath set at 390° C. and thermal degradation was performed. During the thermal degradation, the system was kept at a reduced pressure state of about 2 mmHg and melted polymer was stirred by bubbling with nitrogen gas discharged from a capillary introduced therein. After three hours, the reactor was removed from the metal bath and cooled to room temperature. Thereafter, the reaction system was brought to normal pressure. The residue in the reactor was dissolved in heat xylene and thereafter added dropwise in methanol and purified by reprecipitation. The obtained iPP-TVD had a yield of 77%, a number average molecular weight (Mn) of 7500, a dispersity index (Mw/Mn) of 1.78, and an average number of terminal double bond per molecule (fTVD) was 1.78.

100 g of the obtained iPP-TVD and 600 ml of tetrahydrofuran (THF) were placed in a reactor, and after a nitrogen purge, 80 ml of borane-tetrahydrofuran complex (BH₃-THF) THF solution (1M) was added and heated in a circulating flow for five hours. Then, 100 ml of 5N sodium hydroxide aqueous solution was added in an ice bath and then 100 ml of 30% hydrogen peroxide aqueous solution was added, and successively, heated in a circulating flow for 15 hours. After the reaction, a reaction mixture was poured into methanol, and reprecipitated and refined to obtain iPP-OH.

100 g of the obtained iPP-OH, 10 ml of triethylamine and chloroform were placed in a reactor, and after a nitrogen purge, a chloroform solution of 2-bromoisobutyryl bromide (BiBB) (BiBB/CHCl₃=10 ml/50 ml) was added dropwise and stirred at room temperature for 24 hours. After the reaction, a reaction solution was poured into a 1NHCl/methanol solution, and was reprecipitated and refined to synthesize iPP-Br.

### Example 2-2

### Synthesis of Poly(t-Butylacrylate)-Polypropylene-Poly(t-Butylacrylate) (iPP-PtBA)

100 g of iPP-Br obtained in Example 2-1 and 3 g of copper bromide (I) were placed in a separable flask, and after a nitrogen purge, 100 ml of deaerated t-butylacrylate, 500 ml of toluene and 8 ml of PMDETA were added, and after stirring at room temperature for 30 minutes, heated and stirred at 120° C. for 12 hours. After the reaction, a reaction solution was poured into methanol, and reprecipitated and refined.

### Example 2-3

### Synthesis of Polyacrylic Acid-Polypropylene-Polyacrylic Acid (iPP-PAA)

100 g of iPP-PtBA obtained in Example 2-2 was placed in a flask, and after a nitrogen purge, 200 ml of trifluoroacetic acid and 600 ml of dehydrated chloroform were added and stirred at room temperature for 24 hours. After the reaction, the solvent, the trifluoroacetic acid and t-butyl alcohol were removed by distillation and iPP-PAA was obtained.

### Example 2-4

### Synthesis of Ionomer: Sodium Polyacrylate-Polypropylene-Sodium Polyacrylate (iPP-PAA/Na)

To 750 ml of methanol dispersion of 100 g of iPP-PAA obtained by Example 2-3, a 1N sodium hydroxide aqueous solution was added dropwise and stirred. Then, iPP-PAA/Na, which is an ionomer, was obtained as sediment.

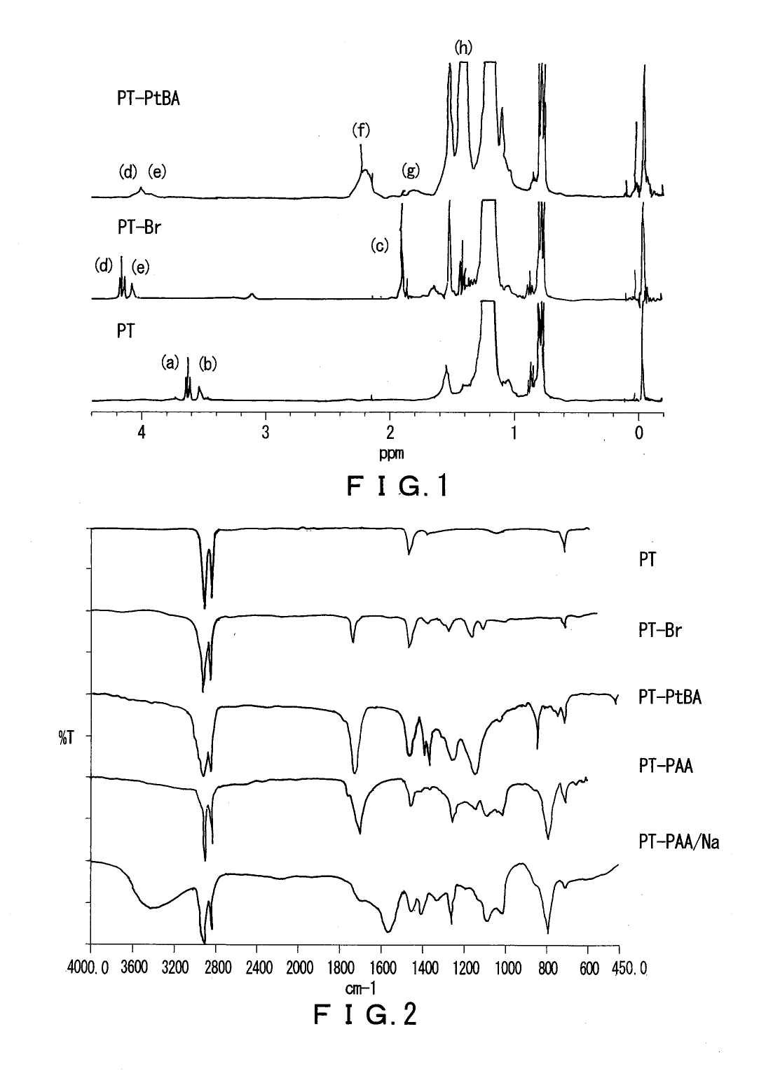

FIG. 1 shows 1H-NMR spectra of PT, PT-Br and PT-PtBA synthesized as described above. In the spectrum of PT-Br, signals of terminal hydroxyl group neighboring methylene proton (a) and methine proton (b) seen in PT disappeared, and signals of terminal methyl proton (c), an ester group-neighboring methylene (d) and methine proton (e) appeared. In PT-PtBA, signals (f), (g) and (h) originating from PtBA appeared and an ester group-neighboring methylene (d) and methine proton (e) shifted.

FIG. 2 shows IR spectra of PT, PT-Br (Example 1-1), PT-PtBA (Example 1-2-1), PT-PAA (Example 1-3-1) and PT-PAA/Na (Example 1-4-1). In PT, absorption peaks due to C—O stretching and in-plane OH bending vibration of primary alcohol appeared at 3600 cm⁻¹, 1305 cm⁻¹ and 1045 cm⁻¹, an absorption peak due to C—H stretching vibration of hydrogen bonded to a tertiary carbon appeared at 2890 cm⁻¹, and absorption peaks due to C—H symmetrical bending vibration appeared at 2900 cm⁻¹, 1460 cm⁻¹, 1380 cm⁻¹ and 725 cm⁻¹. In PT-Br, an absorption peak corresponding to stretching vibration of carbonyl newly appeared at 1740 cm⁻¹ and an absorption peak corresponding to a tertiary butoxy group appeared at 1175 cm⁻¹. In PT-PtBA, absorption peaks corresponding to stretching vibration of carbonyl appeared at 1740 cm⁻¹ and corresponding to a tertiary butoxy group appeared at 1260 cm⁻¹ and 1175 cm⁻¹. Further, in PT-PAA, the absorption peak of 1740 cm⁻¹ due to carbonyl shifted to 1710 cm⁻¹. This is because an ester moiety of PT-PtBA was converted into carboxylic acid. Further, in PT-PAA/Na, a peak of 1710 cm⁻¹ due to carbonyl decreased, and absorption peaks due to out-of-plane bending vibration of carboxylate (COO—) indicating the ionomer formation newly appeared at 1580 cm⁻¹ and 1425 cm⁻¹, and production of PT-PAA/Na was confirmed.

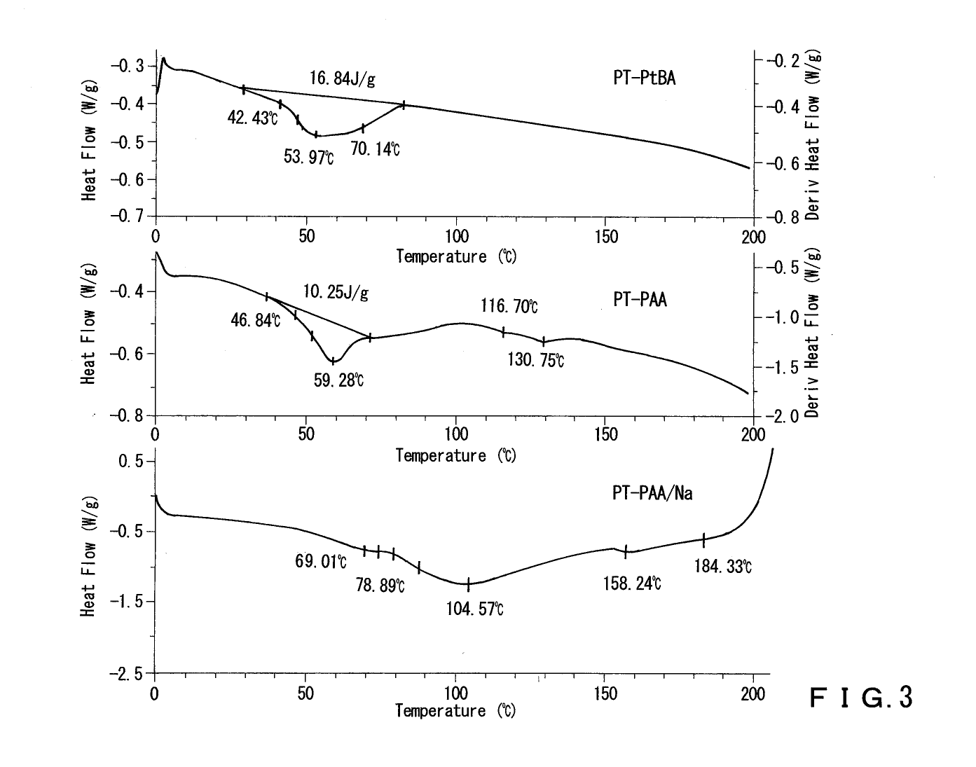

FIG. 3 shows DSC measurement results of PT-PtBA (Example 1-2-1), PT-PAA (Example 1-3-1) and PT-PAA/Na (Example 1-4-1). PT-PAA/Na showed a crystalline melting temperature of a high value of 104.57° C., whereas PT-PtBA showed a crystalline melting temperature of 53.97° C. and PT-PAA showed a crystalline melting temperature of 59.28° C. Also, iPP-PAA/Na showed a crystalline melting temperature of a high value of 146° C. Depending on a composition ratio of ethylene and methacrylic acid, a sodium salt of ethylene/methacrylate random copolymer known as an ionomer in the related art does not crystallize, and even if it does crystallize, a crystalline melting temperature was around 80° C. The ionomer of the present disclosure is a material that has a high crystalline melting temperature, and an improved heat resistance.

An ionomer of the related art was a random copolymer in which a little amount of ionizable groups are randomly inserted into a hydrophobic polymer such as polyethylene, or a graft copolymer in which a little amount of ionizable groups are grafted at random positions of a hydrophobic polymeric chain. With such an ionomer, a melting point derived from a hydrophobic polymer is higher than a melting point derived from an ionizable group. Also, regarding the crystalline melting enthalpy, a crystal melting enthalpy due to a hydrophobic polymer is higher than a crystal melting enthalpy due to an ionic group. Due to such thermal properties, the heat resistance of the ionomer of the related art depends on a melting point of the hydrophobic polymer. Therefore, an ionomer having a good heat resistance did not exist.

In contrast, the ionomer of the present disclosure has an ABA-type triblock structure in which an A-block is an ionic polymer block and a B-block is a non-ionic polymer block. The ionomer of the present disclosure shows that a melting point and a crystalline melting enthalpy due to an ionicity polymer are higher than a melting point and a crystalline melting enthalpy due to a non-ionic polymer. Therefore, the ionomer of the present disclosure has a good heat resistance and a wider range of application as a material of an ionomer can be expected.

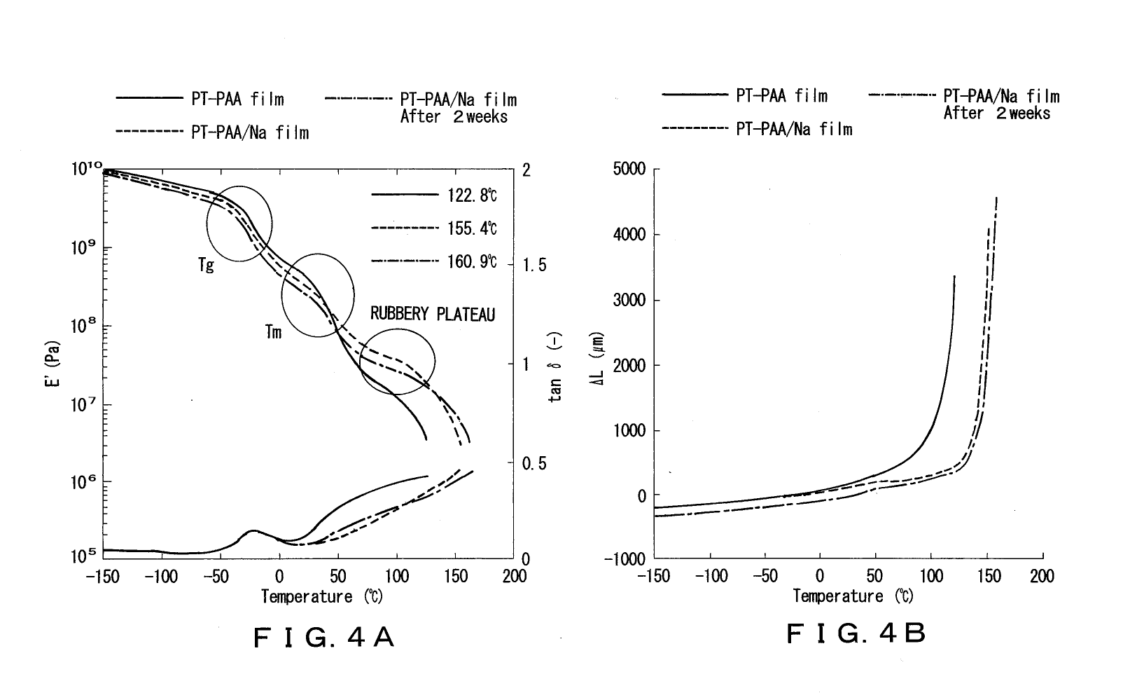

FIGS. 4A and 4B show dynamic viscoelasticity measurement results of films of PT-PAA (Example 1-3-2), PT-PAA/Na (Example 1-4-2), and PT-PAA/Na (Example 1-4-2) aged for two weeks, each heat pressed at 100° C., 30 MPa for 30 minutes. The rupture temperature of PT-PAA was 122.8° C.; the rupture temperature of PT-PAA/Na was 155.4° C.; and the rupture temperature of PT-PAA/Na aged for two weeks was 160.9° C.

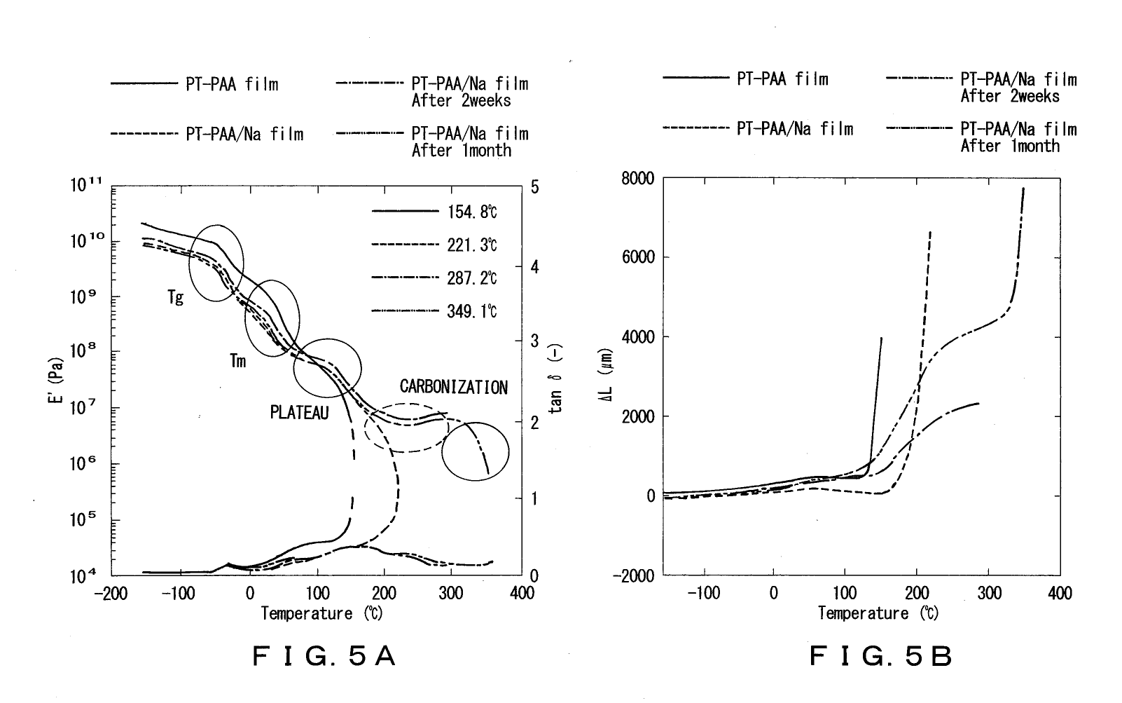

FIGS. 5A and 5B show dynamic viscoelasticity measurement results of films of PT-PAA (Example 1-3-3), PT-PAA/Na (Example 1-4-3), and PT-PAA/Na (Example 1-4-3) aged for two weeks, and PT-PAA/Na (Example 1-4-3) aged for one month each heat pressed at 100° C., 30 MPa for 30 minutes. The rupture temperature of PT-PAA was 154.8° C.; the rupture temperature of PT-PAA/Na was 221.3° C.; the rupture temperature of PT-PAA/Na aged for two weeks was 287.2° C.; and the rupture temperature of PT-PAA/Na aged for one month was 349.1° C.

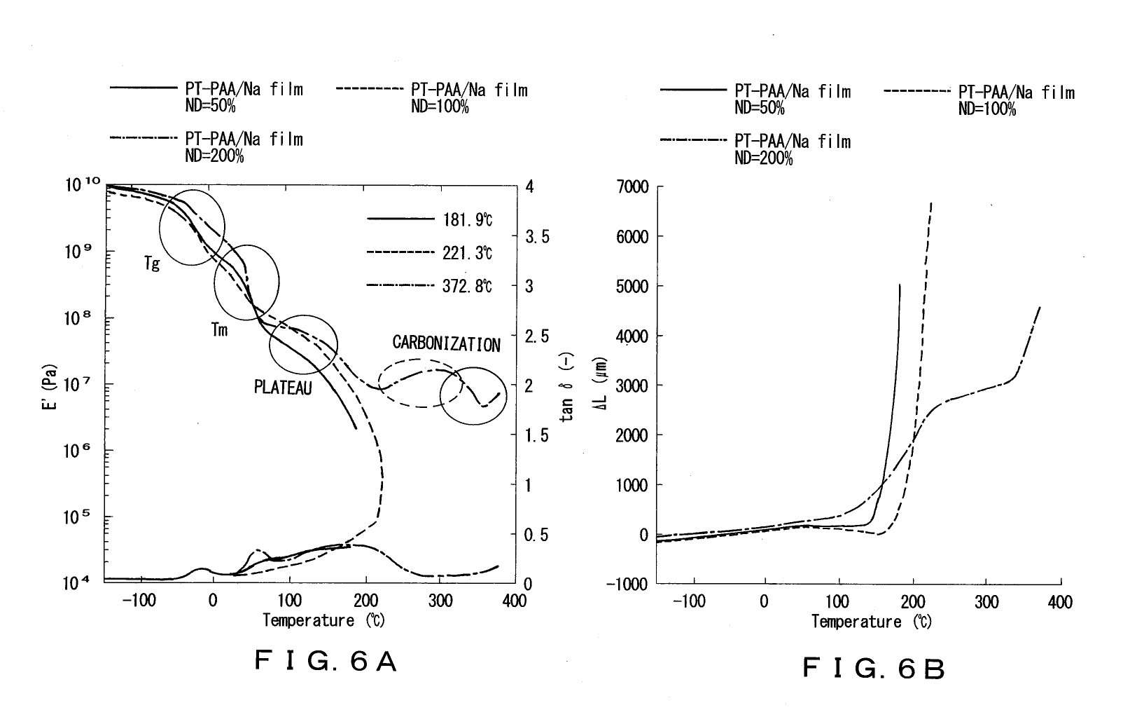

FIGS. 6A and 6B show dynamic viscoelasticity measurement results of films of PT-PAA/Na (Example 1-4-3 (degree of neutralization: 100%)), PT-PAA/Na (Example 1-4-4 (degree of neutralization: 50%)) and PT-PAA/Na (Example 1-4-5 (degree of neutralization: 200%)), each heat pressed at 100° C., 30 MPa for 30 minutes. The rupture temperature of PT-PAA/Na (degree of neutralization: 100%) was 181.9° C.; the rupture temperature of PT-PAA/Na (degree of neutralization: 50%) was 221.3° C.; and the rupture temperature of PT-PAA/Na (degree of neutralization: 200%) was 372.8° C.

In each film, it was observed that stock elasticity modulus (E′) decreased at around −50° C. and around 50° C. to 60° C. It can be considered that this is due to a glass transition point and a melting point of PT. In PT-PAA/Na, a rubbery plateau was observed around 100° C. to 150° C. Further, at 300° C. or above, a change in E′ that is considered to have occurred due to carbonization was observed. Referring to FIGS. 4A, 4B, 5A and 5B, it can be seen that PT-PAA/Na has a higher rupture temperature than PT-PAA, and that the rupture temperature increased when an aging period was increased. Further, referring to FIGS. 6A and 6B, it was seen that the rupture temperature increased as the degree of neutralization of PT-PAA/Na was increased. It is considered that this is because, due to an increase in a number of domains in an ionomer and an aging of the domains in the ionomer, a pseudo-crosslink density has increased by ion aggregates.

What is claimed is:

1. An ionomer having an ABA-type triblock structure, wherein
an A-block is an ionic polymer block including a structural unit having a general formula (i) expressed as follows:
—(CH₂—CR¹(COOM_{1/y})-
where
R¹ is one of a methyl group and hydrogen,
M is one of metal, NH₄, organic ammonium and imidazolium, and
y is a valence of an M ion; and
a B-block is a nonionic polymer block selected from a group consisting of an olefin (co) polymer block, a vinyl (co) polymer block, a diene (co) polymer block, a polyester resin block and a polycarbonate resin block.

2. The ionomer according to claim 1, wherein the B-block is an olefin (co) polymer block.

3. The ionomer according to claim 2, wherein the olefin (co) polymer block is selected from a group consisting of a polyethylene block, a polypropylene block, polyl-butene block, polyisobutylene block, a propylene-ethylene copolymer block, a propylene-1-butene copolymer block and an ethylene-1-butene copolymer block.
